(19) United States
(12) Patent Application Publication
(10) Pub. No.: US 2026/0208964 A1
(43) Pub. Date: Jul. 23, 2026

(54) TAKE-UP SYSTEM WITH INTEGRATED CONVEYOR TENSION-INDICATING MECHANISM

(71) Applicant: Punching Concepts, Inc., Alpena, MI (US)

(72) Inventors: Patrick Kelley, Herron, MI (US); Brian J. Konieczny, Posen, MI (US); James A. Rivard, JR., Alpena, MI (US); Maximus Secrest, Alpena, MI (US)

(21) Appl. No.: 19/033,995

(22) Filed: Jan. 22, 2025

(51) Int. Cl. B65G 23/44

(52) U.S. Cl. CPC B65G 23/44

(57) ABSTRACT

A take-up system which is capable of not only its intended design purpose of applying tension to a belt conveyor system, but which also includes an internal mechanism for measuring the force which is applied, regardless of whether that force is in tension or compression. This take-up mechanism utilizes a force-measuring mechanism, such as a coil spring of a known spring constant, to accurately measure the force, in conjunction with an indicator scale that provides a real time read out of that force to the user. In one embodiment, the take-up system includes components that provide force readings in a single direction, but those components are selectively reversible so that the take-up system provides force readings when the take-up system is coupled to a pulley in a “push” configuration or in a “pull” configuration.

### BACKGROUND OF THE INVENTION

The present invention relates to conveyor systems, and more particularly to ‘take-up’ systems, such as those that eliminate conveyor belt slack and provide tensile loading onto the conveyor belt.

Take-ups are mechanisms on conveyor belt systems that provide movement of a pulley such that moving the pulley changes the tension on the conveyor belt. Maintaining proper force on the belt prevents it from slipping or sagging. Similarly, on chain conveyors, take-ups move a sprocket that keeps the drive chain attached to the sprocket in proper tension without slack. The belt or chain is always put in tension by the take-up, but a take-up can apply this tension by either pushing or pulling the attached belt or chain, depending on the take-up's orientation. The take-up may either be directly integrated into the conveyor structure or may be mounted to the structure as a separate take-up frame.

Take-up frames come in various types and sizes. The specific frame type depends on the application and conveyor frame mounting structure. Some of these frame types have included springs to help absorb shock loads on the belt.

Previous take-up frame mechanisms have been devised such that they use force-indicating mechanisms, both indirectly through measuring spring displacement before and after load is applied and using the spring's spring constant to directly convert the displacement into a live force readout on a scale. However, these designs are only able to be used in the specific push or pull operating scenario that they were originally designed for.

As a result, there remains a long-felt and unmet need for improvements in take-up mechanisms.

### SUMMARY OF THE INVENTION

The present invention provides a take-up system with a gauge assembly for measuring loads on the take-up system due to take-up system adjustment in either push or pull directions, using the same take-up system and the parts included with it. For illustrative purposes, this document will refer specifically to conveyor belt configurations unless otherwise noted. In some embodiments, the present invention can be configured to operate in push or pull directions, merely by reversing the arrangement of the load-indicating mechanism(s). In other embodiments, the present invention can be configured to work in push and pull directions without the need for reconfiguration.

In one embodiment, a spring between two adjustment nuts compresses under loading, moving an indicator along a scale that reads off the force in proportion to the spring's compression distance. The adjustment nuts, indicator, and scale are made such that they can be rearranged to measure force whether the take-up frame is mounted in tension (pull) or compression (push) configurations. The ability for rearrangement is accomplished by making the components reversible, and by making the housing able to accept the components no matter the forward or reversed configuration. For example, in a coil-spring-based embodiment of the invention, the two nuts on either side of the spring are manufactured such that they have the same overall shape to fit inside the housing containing them (or, in combination with spacers or other components, have functionally-equivalent overall shapes). One nut serves as the indicator of the spring's displacement under load, either directly or by connecting to an indicator pin or other indication device. This movement is shown by the pin's movement in a slot on a force-indicating scale, which, according to Hooke's Law and the spring's spring constant, reads off the force on the system. When the nuts are flipped in position and the scale rotated around, the system functions exactly the same as before, but now in the opposite push/pull direction.

In another embodiment, the take-up frame would contain two springs with a threaded nut in between them, allowing the springs to measure the force applied to the frame whether it was operating with the adjustment screw in the push or pull scenario, without having to rearrange internal parts.

The present invention would be attached to a conveyor pulley on one or both sides of the conveyor frame, such that the total force on the take-up system is the sum of the loads indicated on each individual frame. Typically, the forces on both sides of the conveyor frame will be equal or nearly so, but there may be applications where it is beneficial to have unequal take-up forces on each side of the conveyor frame.

The present invention provides a simple and effective take-up system with an integrated tension measuring assembly that provides a visual indication of the force applied to the take-up system, thereby facilitating proper belt tensioning to reduce the risk of slippage and prevent undesired belt sage. In some implementations, the take-up system includes internal components that can be quickly and easily reversed to allow the take-up system to operate in either a push orientation or a pull orientation. This eliminates the need to manufacture, stock and supply two different take-up systems, as well as eliminating the need to determine in advance and specify the appropriate take-up system. Instead, any adjustment to accommodate a push or pull implementation can be readily made in the field. This approach reduces the cost of components as the take-up system includes a minimal number of parts. In other implementations, the take-up system is configured to operate in push or pull orientations without the need for any internal adjustment. This alternative approach eliminates the labor associated with reversing the internal components, but generally requires additional internal components. As a result, this alternative approach may be more suitable when the cost of in-field adjustment is deemed to be greater than the cost of the additional internal components.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and are being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1A is the take-up system configured for the “push” configuration.

FIG. 1B is an exploded version of the take-up system of FIG. 1A showing the operation of the force-indicating system in a “push” configuration.

FIG. 2A is the take-up system configured for the “pull” configuration.

FIG. 2B is an exploded version of the take-up system of FIG. 1A showing the operation of the force-indicating system in a “pull” configuration.

FIG. 3A is another embodiment of the take-up frame containing two springs, which allow the scale to work in either tension or compression without having to physically change the configuration of the internal parts.

FIG. 3B is the same embodiment of FIG. 3A with the scale removed to better view the internal components.

FIG. 4A is a view of the invention in application when used in the push configuration with portions of the cover plate cut away to show underlying structure.

FIG. 4B is the same as FIG. 4A except emphasizing the spring in its uncompressed state.

FIG. 4C is the same view as FIG. 4B except the spring is in the compressed state.

FIG. 5A is a view of the invention in application when used in the pull configuration, with the scale cut away to easily view the spring in the uncompressed state.

FIG. 5B is the same as FIG. 5A except emphasizing the spring in its uncompressed state.

FIG. 5C is the same view as FIG. 5B except the spring is in the compressed state.

### DETAILED DESCRIPTION

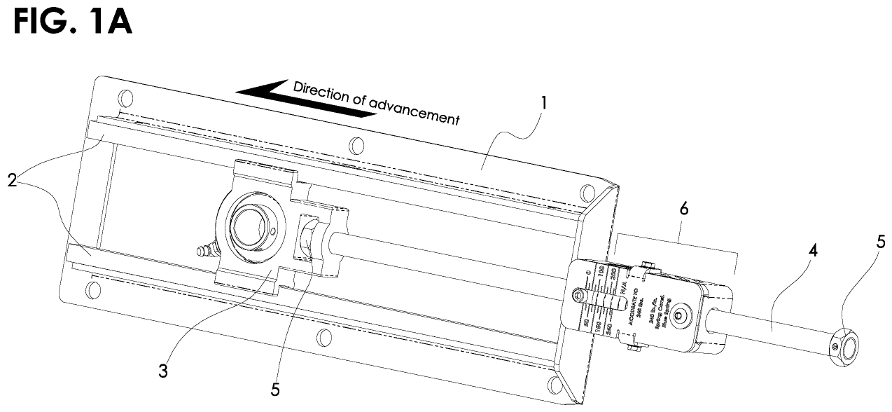

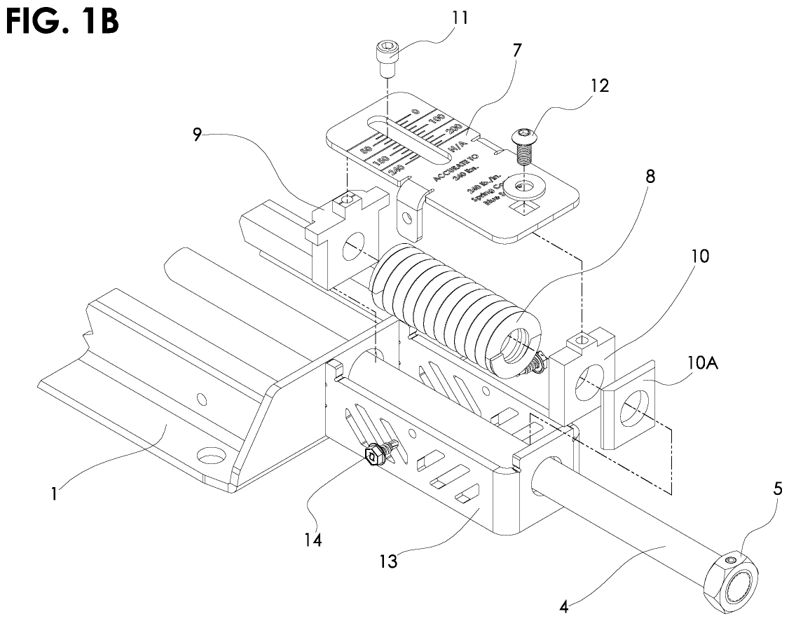

A take-up system in accordance with an embodiment of the present invention is shown in FIG. 1A. The system of this embodiment includes a base frame 1 supporting guide rails 2, on which slide a housed wide-slot take-up bearing 3. As shown, this embodiment includes an adjustment screw consists of a threaded rod 4 and hex nuts 5a-b. The hex nuts 5a-b are fixed to the rod 4, for example, by set screws, so that the hex nuts 5a-b rotate with the rod 4. Hex nut 5a rotatably secures one end of the threaded rod 4 to the take-up bearing 3, while hex nut 5b provides a structure to facilitate adjustment of the take-up system by rotation of the threaded rod 4. For example, hex nut 5b can be rotated by a corresponding wrench or socket to adjust the position of the bearing 3 along the guide rails 2. The illustrated rod/nut combination is merely exemplary and may be replaced by other structures, such as a large bolt with a single hex nut. In the embodiments of FIGS. 1A-2B and 4A-5C, the present invention involves adding the functionality of a reversible force-measurement device incorporated into the system. This force-measurement device is integrated into the take-up system of FIGS. 1A-B, and consists of additional parts attached to the base frame 1 in area 6 as shown in FIG. 1A and highlighted in FIG. 1B.

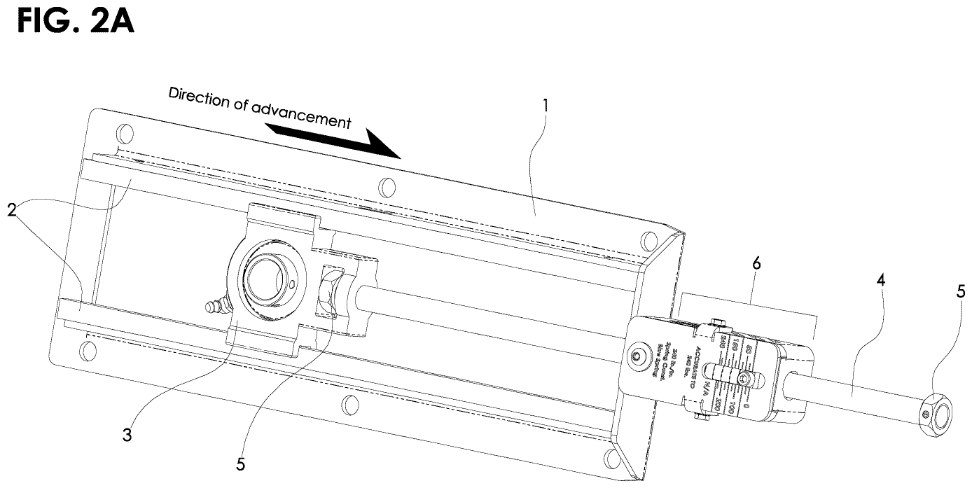

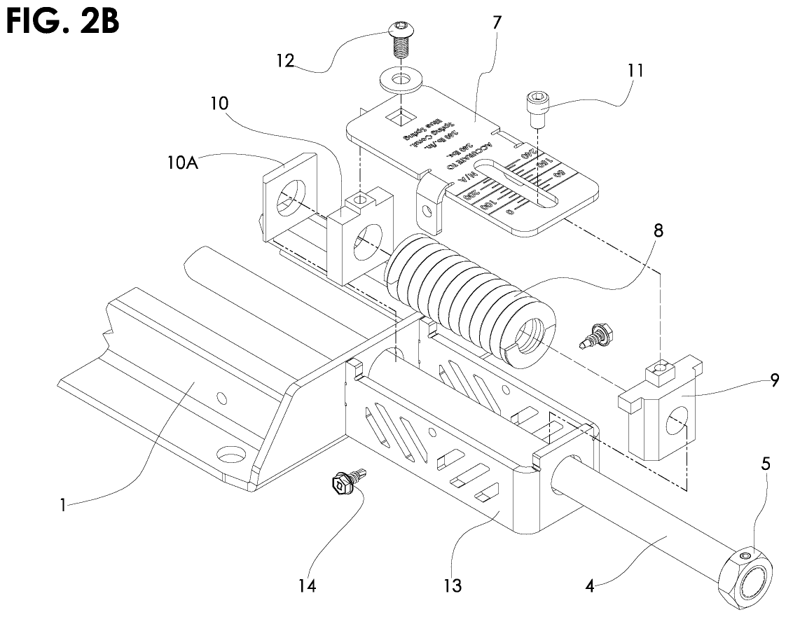

In FIG. 1B, a housing 13 is attached to the base frame 1. The housing 13 defines an internal space partially enclosing a coil spring 8, threaded nut 9, non-threaded nut 10 and spacer 10A. In the illustrated embodiment, the housing 13 is generally rectangular and may include one or more open sides, such as open front and back sides as shown in FIG. 1B. In the illustrated embodiment, the housing 13 is formed primarily by a generally U-shaped component that is affixed directly to the base frame 1, such as by welding or other conventional techniques. As shown, the end wall of the frame 1 closes one end of the housing 13. The illustrated housing 13 includes screw holes for attaching a reversible cover plate 7 in either the push orientation (FIGS. 1A-B) or the pull orientation (FIGS. 2A-B) as described in more detail below. The threaded rod 4 passes through both openings in both ends of the housing 13 (more specifically, through an opening defined in the end wall of the U-shaped component and an opening defined in the end wall of the frame 1). The threaded rod 4 serves as the mechanism to adjust the bearing 3, which is attached to a pulley (not shown in FIG. 1A) to push a conveyor belt (not shown in FIG. 1A) tighter. A spring 8 is disposed upon the threaded rod and is between the threaded nut 9 and non-threaded nut 10. Although the spring 8 shown in the illustrations is a coil spring, the spring may in alternative applications be replaced by other suitable elastic and resilient components, including other metal and elastomeric springs.

In the illustrated embodiment, the position of threaded nut 9 varies within the housing 13 as a function of the position of the bearing 3 within the frame 1 and the position of the nut 9 along the length of the threaded rod 4. Once the spring 8 is placed under a load, the position of threaded nut 9 within the housing 13 is proportional to the load applied to the spring 8. As a result, in the illustrated configuration, the position of the thread nut 9 relative to the housing 13 presents a visual indication of the amount of tension within the take-up system once the spring 8 is under load. To provide a reliable for translating the position of the threaded nut 9 into the load on the system, the take-up system may include a graduated scale position at or near the threaded nut 9. The graduated scale is oriented along the direction of travel of the threaded nut 9 so that the moving threaded nut 9 travels along the scale. In the illustrated embodiment, the graduated scale is printed on the cover plate 7. In the illustrated embodiment, the cover plate 7 defines a slot adjacent to the threaded nut 9 through which the threaded nut 9 is visible throughout its range of motion. The scale is printed adjacent to the slot to provide close physical proximity between the threaded nut 9 and the scale. To further improve correlation between the threaded nut 9 and the scale, an indicator pin 11 is connected to the threaded nut 9, such that the indicator pin is disposed within a slot in the reversible cover plate 7. In the present embodiment, the reversible cover plate 7 is held in place by screws 14 secured to the housing 13, and a bolt 12 connected to the spacer 10, though it could be attached to the housing 13 or base frame 1 in various other ways including but not limited to clamps, welds, or other fastener arrangements. Although the scale is provided on the face of the cover plate 7, the scale may, in alternative embodiments, be located in other locations, such as on the housing 13. For example, a scale oriented for use in push implementations may be provided on one side of the housing and a scale oriented for use in pull implementations may be provided on the opposite side of the housing (not shown), and the user may take readings from the correct scale based on the implementation. In some alternative embodiments, the housing 13 may include a flange or other extension that extends toward the threaded nut 9 and includes the scale to provide closer proximity between the scale the threaded nut 9.

In the illustrated embodiment, as the threaded rod 4 is turned, the threaded nut 9 is forced to advance or retreat along the rod's threads, since it is prevented from rotating in place by being placed in the housing 13's cavity. The illustrated cavity also holds the non-threaded nut 10 and its spacer 10A in place. However, the placement of the parts within a cavity is not necessarily the only method to implement the illustrated invention; all that is required is that the threaded nut 9 be locked from rotating about the adjustment mechanism so that it will travel along the threaded rod 4 when the threaded rod 4 is rotated relative to the housing 13. In some configurations, it may also be helpful for the nonthreaded nut 10 to be fixed against rotation.

When the belt still retains slack, the threaded rod 4 advances through the threaded nut 9, as the force to apply further tension to the belt is less force than to compress the coil spring 8. However, when the belt is taut, it becomes static and hold the threaded rod 4 relatively in place. Continued revolutions of the threaded rod therefore cause the threaded nut 9 to compress the coil spring 8. An indicator pin 11 attached to the threaded nut 9 moves within a slot in the reversible cover plate 7. This cover plate is delineated with indicia converting the displacement of the indicator pin 11 into a readout of the force on the coil spring 8, which is also the force applied to the belt by the take-up system. This conversion is done via Hooke's Law, which states the distance of spring compression or expansion (“x”, symbolically) is directly proportional to the force (“F”) applied to it, with the proportionality constant being the spring constant (“k”); the mathematical equation is F=k*x. Note that the indicated load would be only half of the total belt load if a second identical force-indicating take-up unit were used on the opposite side of the conveyor frame.

FIG. 2A shows the take-up system of FIG. 1A, but configured for the opposite direction of motion for the bearing; a pull configuration. Importantly, the components inside the tension-indicating region 6 are reversed. This is shown in FIG. 2B. The housing 13 remains unchanged in its attachment to the formed base 1. The coil spring 8 remains disposed about the threaded rod 4. However, the threaded nut 9, and the non-threaded nut 10 and the spacer 10A have been swapped in location, and the reversible cover plate 7 has been rotated to face the opposite direction as in FIG. 1. Now, when the threaded rod 4 is turned in the same manner as described for the preceding figures, and force begins to load onto the system, the threaded nut 9 and indicator pin 11 move in the opposite direction as before while performing the same function of reading out the forces in the system via the indicia on the reversible cover plate 7. Thus, without adding any additional components, the same take-up system can be used to measure load in both push and pull scenarios simply by swapping included parts.

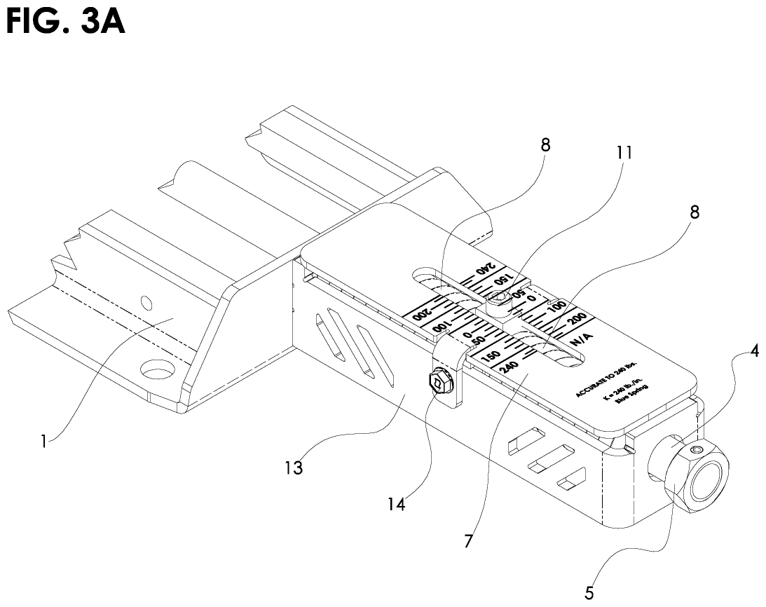

An alternative version of the tension-indicating take-up system, capable of measuring both push and pull loads without rearrangement is shown in FIG. 3A. The housing 13 is extended and the reversible cover plate 7 is lengthened and covered with additional indicia. The cover plate is still attached to the housing via screws 14. As seen in FIG. 3B, two coil springs 8 are disposed upon the threaded rod 4, with the threaded nut 9 centered between them. In a push scenario, as the threaded rod 4 is turned and force is applied to the system, the threaded nut 9 and attached indicator pin 11 move away from the formed base 1, reading off the load on the indicia in that direction. Similarly, in a pull scenario, as the threaded rod 4 is turned and force is applied to the system, the threaded nut 9 and attached indicator pin 11 move toward the formed base 1, reading off the load on the indicia in that direction. Thus, the dual-spring system is able to be placed in applications where both push and pull take-up scenarios could be present.

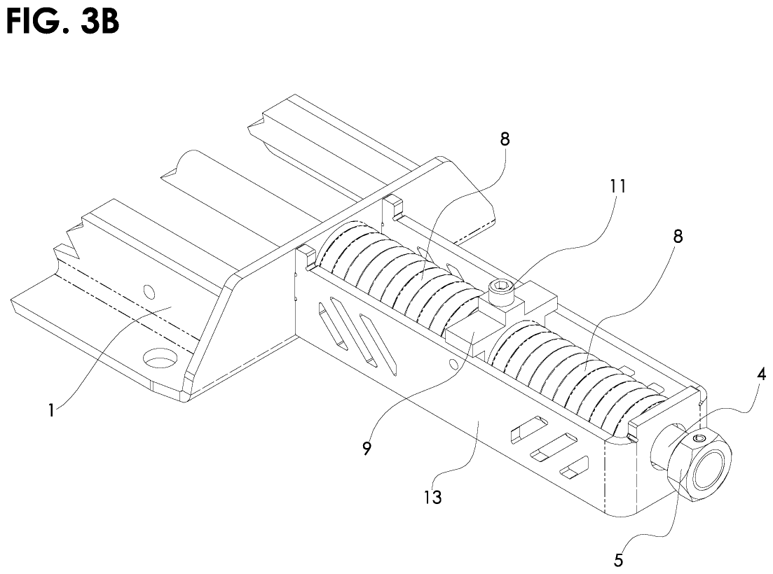

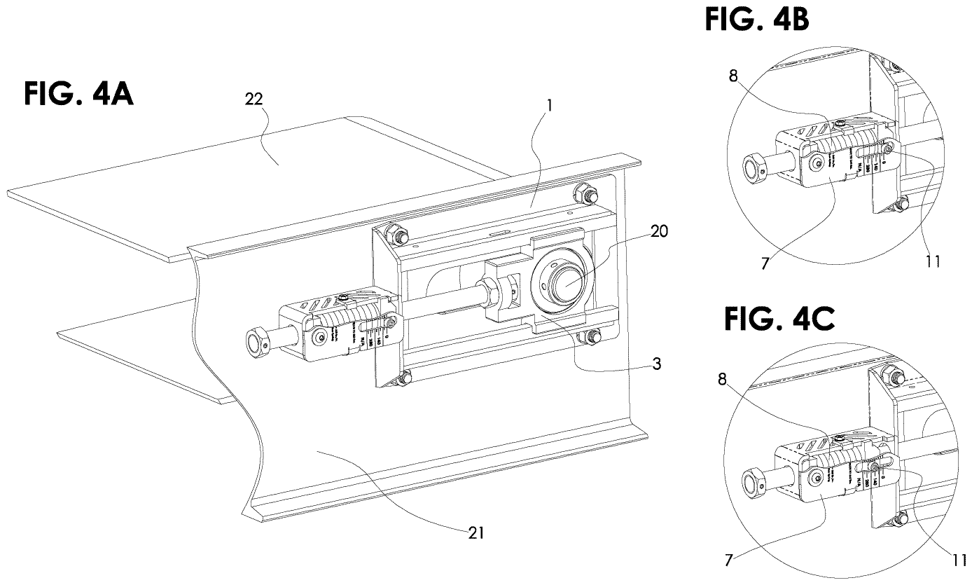

A take-up system in accordance with an embodiment of the present invention on a conveyor frame as it would be in a push application is shown in FIG. 4A. The formed base 1 of the tension-indicating take-up system is attached to a conveyor side frame 21. The bearing 3 in the take-up system is attached to a pulley and its shaft 20. The conveyor belt 22 is wrapped around the pulley. As the bearing 3 is advanced by the take-up system, it pushes the pulley 20 into the belt 22 to lessen slack. FIG. 4B is a detail view of the tension-indicating components during no load or during the time when the belt stretches but is not fully taut. FIG. 4C shows the same region as FIG. 4B, but when the belt is taut and load is applied to the take-up system. The coil spring 8 has compressed, and the indicator pin 11 has proportionally advanced in the reversible cover plate 7.

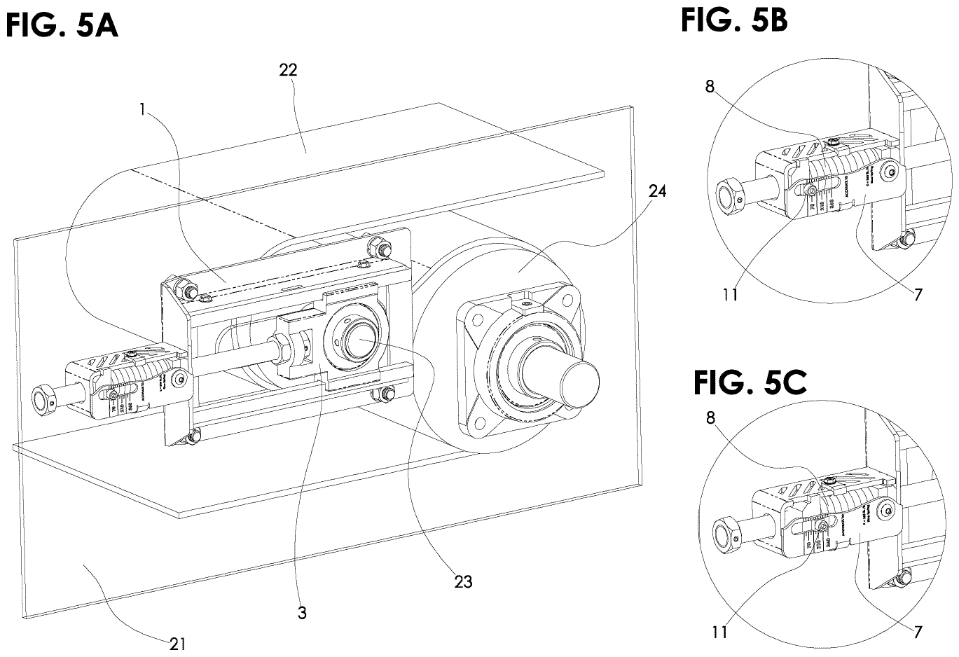

FIG. 5A alternatively shows a pull application, the complement application to FIG. 4A. The take-up system is similarly mounted to a conveyor side frame 21 as before. Here, the belt 22 wraps around a dedicated take-up pulley 23 before engaging with the drive pulley 24. Now, as the bearing is advanced leftward in this illustration, it pulls the take-up pulley 23 into the belt 22 to lessen belt slack. The detail view of FIG. 5B shows the tension-indicating components during no load or during movement but prior to the belt being fully taut. FIG. 5C shows the same region as FIG. 5B, but when the belt is taut and load is applied to the take-up system. The coil spring 8 has compressed, and the indicator pin 11 has proportionally advanced in the reversible cover plate 7, but in the opposite direction as the previous push application, while still using all the same components and tension-indicating mechanisms.

The invention need not be limited to the specific embodiment described above. For example, the coil spring 8 need not be disposed concentrically to the threaded rod 4. One could imagine using an electronic force-indicating mechanism, for example, a linear digital potentiometer, or creating a force-indicating pneumatic or hydraulic system. There is also no reason the spring or other force-reading mechanism be directly integrated into the frame. The critical feature for any of the above cases is that the force-indicating system be reversible or be readable in both push and pull orientations without being reversed.

The embodiments shown are again only illustrative, as there are features that may be altered while retaining the core functionality. For example, the spacer 10A and the non-threaded nut 10 are not strictly necessary; these components are there for improved functionality, but the system could still function if they were to be eliminated. As was previously discussed, the reversible cover plate could be attached to the frame 1 or housing 13 via other means. Furthermore, the scale could be delineated directly on the housing 13 or in other suitable locations.

While the present embodiments apply to a conveyor belt system, the present invention may be incorporated into essentially any conveyor system that requires a take-up mechanism to apply force to a bearing.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Furthermore, the particular features, structures, or characteristics may be combined in any suitable manner in one or more embodiments.

The invention claimed is:

1. A conveyor take-up assembly comprising:
a frame configured to mount adjacent to a conveyor pulley;
a bearing assembly movably coupled to the frame and configured to support one end of a conveyor pulley;
a housing defining an internal space;
a threaded element disposed within the internal space, the threaded element being fixed against rotation within the housing;
a threaded rod coupled to the bearing assembly and threadedly engaged with the threaded element within the housing; and
a force indication assembly providing a visual representation of force on a conveyor pulley supported by the bearing assembly, the force indication assembly being associated with the threaded element and providing the visual representation as a function of a position of the threaded element relative to at least one of the threaded rod and the housing.

2. The take-up assembly of claim 1 further including a scale having a plurality of visual indications cooperating with the force indication assembly.

3. The take-up assembly of claim 2 wherein the housing includes a removable cover, the scale being disposed on the removable cover.

4. The take-up assembly of claim 1 further including a resilient compressible element disposed in the housing adjacent to the threaded element, the resilient compressible element offering increasing resistance to movement of the threaded element within the housing.

5. The take-up assembly of claim 4 wherein the resilient compressible element is a spring.

6. The take-up assembly of claim 4 wherein the resilient compressible element is a coil spring, the coil spring being disposed about the threaded rod.

7. The take-up assembly of claim 6 further comprising an indicator extending from the threaded element, the indicator disposed in a position adjacent to the scale, whereby movement of the threaded element moves the indicator along the scale.

8. The take-up assembly of claim 1 wherein the threaded element has a first side and a second side; and
further including a resilient compressible element disposed in the housing on the first side of the threaded element, the resilient compressible element offering increasing resistance to movement of the threaded element in a first direction within the housing, the force indication assembly including a scale providing graduations associated with movement of the threaded element in the first direction.

9. The take-up assembly of claim 8 wherein the resilient compressible element is readily movable to the second side of the threaded element, whereby the compressible element offers increasing resistance to movement of the threaded element in a second direction within the housing, the force indication assembly including a scale providing graduations associated with movement of the threaded element in the second direction.

10. The take-up assembly of claim 8 wherein the resilient compressible is a spring, the spring being selectively movable between a first position between the first side of the threaded element and the housing and a second position between the second side of the threaded element and the housing.

11. The take-up assembly of claim 10 wherein the spring is a coil spring fitted about the threaded rod.

12. The take-up assembly of claim 11 further including a non-threaded nut fitted over threaded rod and disposed between the spring and the housing.

13. The take-up assembly of claim 12 further including a spacer fitted over the threaded rod and disposed between the non-threaded nut and the housing.

14. The take-up assembly of claim 13 further including a removable cover, the cover being removably attached to the housing, the housing including the scale, the non-threaded nut being secured to the cover.

15. The take-up assembly of claim 1 wherein the threaded element has a first side and a second side; and
further including:
a first resilient compressible element disposed in the housing on the first side of the threaded element, the first resilient compressible element offering increasing resistance to movement of the threaded element in a first direction within the housing, the force indication assembly including a scale providing a first set of graduations associated with movement of the threaded element in the first direction; and
a second resilient compressible element disposed in the housing on the second side of the threaded element, the second resilient compressible element offering increasing resistance to movement of the threaded element in a second direction within the housing, the force indication assembly including a scale providing a second set of graduations associated with movement of the threaded element in the second direction, the second set of graduations being separate from the first set of graduations.

16. The take-up assembly of claim 15 wherein the first resilient compressible is a first coil spring fitted over the threaded rod and the second resilient compressible is a second coil spring fitted over the threaded rod.

17. A conveyor take-up apparatus, comprising:
a base structure supporting a conveyor pulley;
an adjustment mechanism configured to move the conveyor pulley;
a force-indicating device used in conjunction with the adjustment mechanism, such that the force-indicating device provides a visual indication of force in take-up adjustments in either a push or pull arrangement.

18. The conveyor take-up apparatus of claim 17 where the force-indicating device is integrated into the take-up adjustment mechanism and is selectively movable between a first position to provide a visual indication of force in take-up adjustments in a push arrangement and a second position to provide a visual indication of force in take-up adjustments in a pull arrangement.

19. The conveyor take-up apparatus of claim 18 where the force-indicating device includes at least one coil spring of known spring constant and a reversible force-indicating scale.

20. The conveyor take-up apparatus of claim 17 wherein the force-indicating device includes at least one of a reversible force-indicating scale that is reversible to permit use in push and pull arrangements and a force-indicating scale which indicates force in both pull and push arrangements via an indicator in about a center of the scale.
